(19) United States
(12) Patent Application Publication
(10) Pub. No.: US 2004/0148074 A1
(43) Pub. Date: Jul. 29, 2004

(54) System and method for monitoring the vehicle dynamics of a vehicle

(76) Inventors: Ulrich Hessmert, Schwieberdingen (DE); Norbert Polzin, Zaberfeld (DE); Helmut Wandel, Markgroeningen (DE); Thomas Sauter, Remseck (DE); Jost Brachert, Ditzingen (DE)

Correspondence Address: KENYON & KENYON, ONE BROADWAY, NEW YORK, NY, 10004, US

(21) Appl. No.: 10/220,641

(22) PCT Filed: Dec. 22, 2001
(86) PCT No.: PCT/DE01/04907

(30) Foreign Application Priority Data
Dec. 30, 2000 (DE) 100 65 765.6
May 9, 2001 (DE) 101 22 405.2

(51) Int. Cl. G06F 19/00

(52) U.S. Cl. 701/38; 280/5.5

(57) ABSTRACT

The present invention relates to a system for monitoring the driving condition of a vehicle having a sensor suite (10) measuring the wheel force for ascertaining a wheel force at at least one wheel (12) of the vehicle, and means (14, 16) for processing the ascertained wheel force, a condition of a shock absorber allocated to the wheel (12) being ascertainable from a result of the processing. The invention also relates to a method for monitoring the driving condition of a vehicle.

The present invention relates to a system for monitoring the driving condition of a vehicle, having a sensor suite measuring the wheel force for ascertaining a wheel force at at least one wheel of the vehicle, and having means for processing the ascertained wheel force. The invention also relates to a method for monitoring the driving condition of a vehicle, including the steps: Ascertaining a wheel force at at least one wheel of the vehicle using a sensor suite measuring the wheel force, and processing the ascertained wheel force.

### BACKGROUND INFORMATION

The system of this type and the method of this type are used within the framework of vehicle dynamics controls. For example, they are used in connection with anti-lock braking systems (ABS), traction control systems (TCS) and the electronic stability program (ESP). In this context, it is known to detect the wheel speeds of the individual wheels of a motor vehicle using sensors, and to take the detected wheel speeds into account in the open-loop and/or closed-loop control of the handling characteristics of the motor vehicle. Although good results are already being obtained with the known methods and systems, there is an interest in further improving the methods and systems of this type, particularly in light of roadworthiness.

In connection with the generic sensors provided, it is further known that various tire manufacturers are planning the future use of so-called intelligent tires. In that case, new sensors and evaluation circuits may be mounted directly on the tire. The use of such tires allows additional functions, such as the measurement of the torque occurring at the tire transversely and lengthwise with respect to the direction of travel, the tire pressure or the tire temperature. In this connection, tires may be provided, for example, in which magnetized areas or strips having field lines running preferably in the circumferential direction are incorporated in each tire. The magnetization is implemented, for example, sectionally, always in the same direction, but with opposite orientation, i.e., with alternating polarity. The magnetized strips run preferably in the vicinity of the rim flange and in the vicinity of the tire contact area. The detecting elements therefore rotate with the wheel speed. Appropriate sensing devices are preferably body-mounted at two or more different points in the direction of rotation, and in addition, have a different radial distance from the axis of rotation. It is thereby possible to obtain an inner measuring signal and an outer measuring signal. A rotation of the tire may then be detected via the changing polarity of the measuring signal or measuring signals in the circumferential direction. For example, it is possible to calculate the wheel speed from the rolling circumference and the temporal variation of the inner measuring signal and the outer measuring signal.

It has likewise already been suggested to arrange sensors in the wheel bearing; this arrangement may be carried out both in the rotating and in the static part of the wheel bearing. For example, the sensors may be implemented as microsensors in the form of microswitch arrays. Forces and accelerations, as well as the rotational speed of a wheel are measured, for example, by the sensors positioned on the movable part of the wheel bearing. These data are compared to electronically stored base patterns or to data of a substantially identical or similar microsensor which is mounted on the fixed part of the wheel bearing.

### SUMMARY OF THE INVENTION

The present invention builds on the system of this type, in that a condition of a shock absorber allocated to the wheel is ascertainable from a result of the processing. For motor vehicles having non-functional shock absorbers, critical driving situations may come about in response to strong deceleration, especially on rough road surfaces, or even during normal driving, for example, when cornering. Cornering on poor road surfaces may be particularly critical. The critical situations occur because, for example, the chassis is set into vibration because of a disturbing force, and this vibration cannot be damped by the shock absorber. For instance, a disturbing force may be produced by unevenness in the road or a braking torque that has been initiated. In these cases, the adhesion between tires and roadway may become lost, which may result in critical driving situations. Ascertainment of a condition of a shock absorber allocated to the wheel from the measured wheel forces according to the present invention permits early detection of the loss of a damper function, which ultimately increases driving safety. A sensor suite measuring the wheel force is suitable for the purpose of monitoring the chassis damping, since using it, it is possible to measure the vertical force of the wheel. In response to existing vibrations of the chassis influenced by a disturbing torque, the vertical chassis movement, and thus the measured vertical force are modulated.

In one preferred specific embodiment of the system according to the present invention, it is further developed in that the sensor suite measuring the wheel force has tire sensors. The tire sensors described in connection with the related art are particularly suitable, for example, for measuring the vertical force of a wheel, so that driving safety may be improved to a great extent.

However, it may also be useful for the sensor suite measuring the wheel force to have wheel-bearing sensors. For example, vertical forces of the wheel may also be measured using such wheel-bearing sensors, so that the system of the present invention may be implemented in this manner, as well. In this connection, it should be noted as particularly advantageous that greatly varying sensor suites which measure wheel forces may be modified within the meaning of the present invention.

The system of the present invention shows its special merits in that the force amplitude of a disturbing force is determinable by ascertaining the wheel force, a shock absorber being set into vibration by the disturbing force; that a vibration damping is determinable by ascertaining at least one sequential amplitude of the vibration; that the vibration damping is able to be evaluated; and that the condition of the shock absorber is ascertainable as a function of the evaluation. The introduction of a disturbing torque, for example, in response to a strong braking of a vehicle or due to imperfections in the roadway, leads to vibration of the vehicle. An intact shock absorber unit causes the vibration to quickly die away again. If the damping function is disturbed, the vibration lasts over a period of time which is not tenable in connection with driving safety. If a disturbing force is now introduced from outside, and the measurement of the force amplitude produced by the disturbing force is measured, for example, based on the change in the vertical wheel force, then it is possible to determine and evaluate a value characteristic for the vibration damping by measuring at least one sequential amplitude. It is likewise conceivable that the primary force amplitude, which is produced by the disturbing force, is not used as the initial value for the comparison of the force amplitudes. Rather, any sequential force amplitudes may be used as a measure for the damping.

The invention is further developed in a particularly preferred manner in that the vibration damping is evaluated by comparison to a predetermined critical vibration damping. Such a predetermined critical vibration damping is generally vehicle-specific, and may be represented by a “critical damping constant”. For example, an instantaneous damping constant may be ascertained from the evaluation of the vibration damping and compared to the critical damping constant specific to the vehicle. Optionally, from this comparison it is possible to recognize damping which is inadequate, namely, when the instantaneous damping constant is less than the critical damping constant.

However, it is also possible to evaluate the vibration damping by measuring the temporal variation of successive vibration amplitudes. This percentage decrease may also be a measure for adequate or inadequate damping, so that ultimately countermeasures may be taken.

The system of the present invention is further refined in a particularly advantageous manner in that it is possible to trigger an indicator as a function of the ascertained condition of the shock absorber. In the case of a passenger car, such an indicator may be implemented, for example, via a display in the passenger compartment, so that the driver is informed in time about insufficient damping, and thus about imminent critical driving situations.

In a likewise particularly preferred further refinement of the system according to the invention, a drive-away prevention may be activated as a function of the ascertained condition of the shock absorber.

The present invention builds on the method of the species, in that a condition of a shock absorber allocated to the wheel is ascertained from a result of the processing. Ascertainment of a condition of a shock absorber allocated to the wheel from the measured wheel forces according to the present invention permits early detection of the loss of a damper function, which ultimately increases driving safety. A sensor suite measuring the wheel force is suitable for the purpose of monitoring the chassis damping, since using it, it is possible to measure the vertical force of the wheel. In response to existing vibrations of the chassis influenced by a disturbing torque, the vertical chassis movement, and thus the measured vertical force are modulated.

In one preferred specific embodiment of the method according to the present invention, it is further developed in that the sensor suite measuring the wheel force uses tire sensors. The tire sensors described in connection with the related art are particularly suitable, for example, for measuring the vertical force of the wheel, so that driving safety may be improved to a great extent.

However, it may also be useful for the sensor suite measuring the wheel force to use wheel-bearing sensors. For example, vertical forces of the wheel may also be measured using such wheel-bearing sensors, so that the method of the present invention may be implemented in this manner, as well.

The method of the present invention shows its special merits in that the force amplitude of a disturbing force is determined by ascertaining the wheel force, a shock absorber being set into vibration by the disturbing force; that a vibration damping is determined by ascertaining at least one sequential amplitude of the vibration; that the vibration damping is evaluated; and that the condition of the shock absorber is ascertained as a function of the evaluation. The introduction of a disturbing torque, for example, in response to a strong braking of a vehicle or due to imperfections in the roadway, leads to vibration of the vehicle. An intact shock absorber unit causes the vibration to quickly die away again. If the damping function is disturbed, the vibration lasts over a period of time which is not tenable in connection with driving safety. If a disturbing force is now introduced from outside, and the measurement of the force amplitude produced by the disturbing force is measured, for example, based on the change in the vertical wheel force, then it is possible to determine and evaluate a value characteristic for the vibration damping by measuring at least one sequential amplitude. It is likewise conceivable that the primary force amplitude, which is produced by the disturbing force, is not used as the initial value for the comparison of the force amplitudes. Rather, any sequential force amplitudes may be used as a measure for the damping.

The invention is further developed in a particularly preferred manner in that the vibration damping is evaluated by comparison to a predetermined critical vibration damping. Such a predetermined critical vibration damping is generally vehicle-specific, and may be represented by a “critical damping constant”. For example, an instantaneous damping constant may be ascertained from the evaluation of the vibration damping and compared to the critical damping constant specific to the vehicle. Optionally, from this comparison it is possible to recognize damping which is inadequate, namely, when the instantaneous damping constant is less than the critical damping constant.

However, it is also possible to evaluate the vibration damping by measuring the temporal variation of successive vibration amplitudes. This percentage decrease may also be a measure for adequate or inadequate damping, so that ultimately countermeasures may be taken.

The method of the present invention is further refined in a particularly advantageous manner in that it is possible to trigger an indicator as a function of the ascertained condition of the shock absorber. In the case of a passenger car, such an indicator may be implemented, for example, via a display in the passenger compartment, so that the driver is informed in time about insufficient damping, and thus about imminent critical driving situations.

In a likewise particularly preferred further refinement of the method according to the invention, a drive-away prevention may be activated as a function of the ascertained condition of the shock absorber.

The present invention is based on the finding that by monitoring the shock absorber based on the wheel force, it is possible to ascertain defects or worn shock absorbers early, and to reduce dangerous driving situations. It is conceivable for the system of the present invention to carry out a continuous monitoring. The system may likewise be designed such that it is only activated by the introduction of a relatively large disturbing force, e.g. by a pothole or a manhole cover, since it is possible to obtain particularly reliable measuring results in response to large disturbing forces.

### BRIEF DESCRIPTION OF THE DRAWING

The present invention shall now be clarified in terms of preferred specific embodiments by way of example, with reference to the accompanying drawing, in which:

FIG. 1 shows a block diagram of a system according to the present invention;

FIG. 2 shows a flowchart of a method according to the present invention;

FIG. 3 shows a part of a tire equipped with a tire side-wall sensor; and

FIG. 4 shows exemplary signal patterns of the tire side-wall sensor depicted in FIG. 3.

### DESCRIPTION OF THE EXEMPLARY EMBODIMENTS

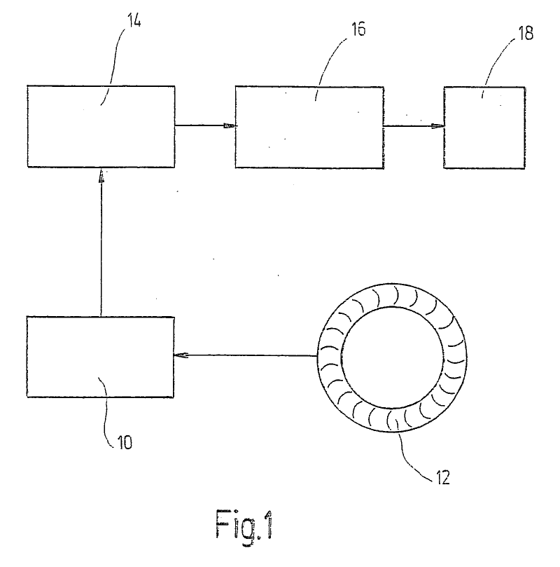

FIG. 1 shows a block diagram of a system according to the present invention. Wheel forces of a wheel 12 are ascertained by a sensor suite 10 measuring the wheel force. Wheel 12 depicted is shown as representative for a plurality of wheels of a vehicle, particularly of a motor vehicle. Sensor suite 10 measuring the wheel force is connected to a device 14 for ascertaining a vibration damping. Device 14 for ascertaining the vibration damping is coupled to a device 16 for evaluating the vibration damping. Device 16 for evaluating the vibration damping is connected to a display device 18.

Sensor suite 10 measuring the wheel force may be a component, for example, of a side-wall sensor. Sensor suite 10 may likewise take the form of a wheel-bearing sensor suite. Sensor suite 10 measures, inter-alia, the vertical force of the tire. The vibration damping is ascertained in device 14 from the signals output by sensor suite 10 to device 14. This ascertainment may be carried out, for example, by measuring successive vibration amplitudes after the introduction of a disturbing force. The vibration damping ascertained in this manner in device 14 is fed to device 16 for evaluation of the vibration damping. For example, the vibration damping may be evaluated by comparing an ascertained damping constant to a critical damping constant specific for the vehicle. It is likewise conceivable to evaluate the percentage decrease of successive amplitudes. A display device 18 is then activated depending on the result of the evaluation. The display device may be provided, for example, in the passenger compartment of a vehicle, and may output a warning indication when the ascertained vibration damping is less than a critical vibration damping, and therefore was evaluated as a critical value in device 16. Alternatively or in addition to alarm device 18, a drive-away prevention may also be provided which presents the vehicle from starting from rest in the event of critical vibration damping values.

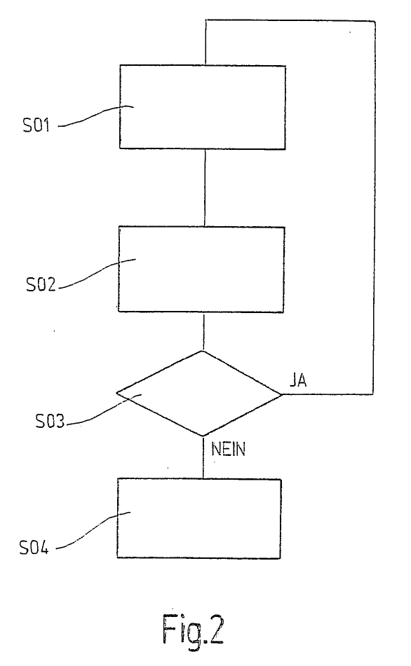

FIG. 2 shows a flowchart of a method according to the present invention. First of all, the meaning of the individual method steps is indicated:

SO1: Measure a wheel force.

S02: Ascertain a vibration damping.

S03: Vibration damping greater than predetermined vibration damping?

SO4: Alarm.

In step S01, a wheel force is measured, for example, the vertical force of a wheel.

In step S02, a vibration damping is ascertained from the results of step S01. This may be accomplished by comparing successive wheel-force amplitudes to one another.

In step S03, the ascertained vibration damping is compared to a predetermined vibration damping. If the ascertained vibration damping is greater than a predetermined vibration damping, this is classified as unproblematic, and the method sequence is able to continue with the normal monitoring operation.

If the vibration damping is less than the predetermined vibration damping, then, for example, an alarm is output in step S04. It is likewise possible to activate a drive-away prevention.

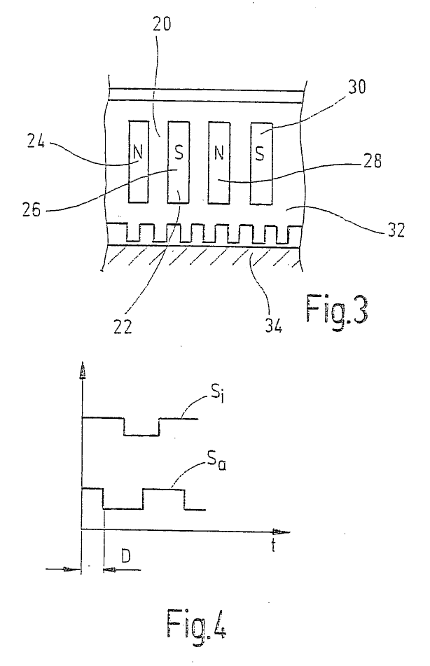

FIG. 3 shows a cut-away portion of a tire 32 having a tire/side-wall sensor suite 20, 22, 24, 26, 28, 30. It includes two sensors 20, 22 which are body-mounted at two different points in the direction of rotation. Furthermore, sensors 20, 22 have a different radial distance from the axis of rotation of the wheel. The side wall of tire 32 is provided with a plurality of detecting elements 24, 26, 28, 30 which have alternating magnetic polarity.

FIG. 4 shows signal patterns Sᵢ and Sₐ of sensor 20 according to FIG. 3 arranged inside, and of sensor 22 according to FIG. 3 arranged outside. A rotation of the tire is detected via the changing polarity of the measuring signals. For example, the wheel speed may be calculated from the rolling circumference of the time variation of signals Sᵢ and Sₐ. Torsions of the tire may be ascertained by phase shifts between the signals, and thus, for example, wheel forces may be measured directly. Within the scope of the present invention, it is particularly advantageous if the vertical force of tire 32 on road 34 according to FIG. 3 can be ascertained, since from this vertical force, conclusions can be drawn in a manner according to the invention about the functioning of the shock absorber.

The preceding description of the exemplary embodiments according to the present invention serves only for illustrative purposes, and not for the purpose of limiting the invention. Various changes and modifications are possible within the framework of the invention, without departing from the scope of the invention and its equivalents.

What is claimed is:

1. A system for monitoring the driving condition of a vehicle, comprising
a sensor suite (10) measuring the wheel force, for ascertaining a wheel force at at least one wheel (12) of the vehicle, and
means (14, 16) for processing the ascertained wheel force,
wherein a condition of a shock absorber allocated to the wheel (12) is ascertainable from a result of the processing.

2. The system as recited in claim 1,
wherein the sensor suite measuring the wheel force has tire sensors (20, 22, 24, 26, 28, 30).

3. The system as recited in claim 1 or 2,
wherein the sensor suite measuring the wheel force has wheel-bearing sensors.

4. The system as recited in one of the preceding claims, wherein
the force amplitude of a disturbing force is ascertainable by determining the wheel force, a shock absorber being set into vibration by the disturbing force,
a vibration damping is ascertainable by determining at least one sequential amplitude of the vibration,
the vibration damping is able to be evaluated, and
the condition of the shock absorber is ascertainable as a function of the evaluation.

5. The system as recited in one of the preceding claims,
wherein the vibration damping is evaluated by comparison to a predetermined critical vibration damping.

6. The system as recited in one of the preceding claims,
wherein the vibration damping is evaluated by measuring the temporal variation of successive vibration amplitudes.

7. The system as recited in one of the preceding claims,
wherein a display (18) can be triggered as a function of the ascertained condition of the shock absorber.

8. The system as recited in one of the preceding claims,
wherein a drive-away prevention can be activated as a function of the ascertained condition of the shock absorber.

9. A method for monitoring the driving condition of a vehicle, having the steps:
ascertaining a wheel force at at least one wheel (12) of the vehicle using a sensor suite measuring the wheel force, and
processing the ascertained wheel force,
wherein a condition of a shock absorber allocated to the wheel (12) is ascertainable from a result of the processing.

10. The method as recited in claim 9,
wherein the sensor suite measuring the wheel force uses tire sensors (20, 22, 24, 26, 28, 30).

11. The method as recited in claim 9 or 10,
wherein the sensor suite measuring the wheel force uses wheel-bearing sensors.

12. The method as recited in one of claims 9 through 11,
wherein
the force amplitude of a disturbing force is ascertained by determining the wheel force, a shock absorber being set into vibration by the disturbing force,
a vibration damping is ascertained by determining at least one sequential amplitude of the vibration,
the vibration damping is evaluated, and
the condition of the shock absorber is ascertained as a function of the evaluation.

13. The method as recited in one of claims 9 through 12,
wherein the vibration damping is evaluated by comparison to a predetermined critical vibration damping.

14. The method as recited in one of claims 9 through 13,
wherein the vibration damping is evaluated by measuring the temporal variation of successive vibration amplitudes.

15. The method as recited in one of claims 9 through 14,
wherein a display (18) can be triggered as a function of the ascertained condition of the shock absorber.

16. The method as recited in one of claims 9 through 15,
wherein a drive-away prevention can be activated as a function of the ascertained condition of the shock absorber.

17. A system for generating a condition signal representing the condition of a motor-vehicle shock absorber, at least one tire and/or one wheel being provided, and a force sensor being mounted in the tire and/or the wheel, particularly on the wheel bearing, and the condition signal being generated as a function of the output signals of the force sensor.
